(19) United States
(12) Patent Application Publication
(10) Pub. No.: US 2010/0190125 A1
(43) Pub. Date: Jul. 29, 2010

(54) TRANSFER JIG FOR BRACKET OR TUBE, MANUFACTURING AND USING METHOD THEREOF

(76) Inventor: Joonho Lee, Geoje-si (KR)

Correspondence Address: Jae Y. Park, Kile, Goekjian, Reed & McManus, PLLC, 1200 New Hampshire Ave. NW, Suite 570, Washington, DC, 20036, US

(21) Appl. No.: 12/669,036

(22) PCT Filed: Jun. 13, 2008
(86) PCT No.: PCT/KR08/03355

§ 371 Date: Jan. 13, 2010

(30) Foreign Application Priority Data
Aug. 9, 2007 (KR) 10-2007-0080234

(51) Int. Cl. A61C 7/02; G06F 17/50; G05B 19/4097

(52) U.S. Cl. 433/3; 433/24; 700/98; 700/118

(57) ABSTRACT

The present invention relates to a transfer jig for a bracket or a tube to perform an orthodontic operation to an actual tooth of a patient by an indirect attachment using an electronic mold, the transfer jig comprising a fixing unit which has a fixing base including a contact surface corresponding to the actual teeth; and a moving unit which has a first side coupled with the fixing unit and a second side detachably attached to at least one of the bracket and the tube. That is, the fixing unit is manufactured by a small/high precision CNC equipment installed in individual dental clinics. The moving unit is attached to a slot of the bracket or tube in the same direction as the coupling direction of the arch wire. The moving unit is rotatably coupled with the fixing unit.

### FIELD OF THE INVENTION

Apparatuses and methods consistent with the present invention relate to a transfer jig for a bracket or a tube, a manufacturing and using method thereof, and more particularly, to a transfer jig for a bracket or a tube which improves a method of measuring, manufacturing and using a bracket or a tube with a computer aided design (CAD) and computer aided manufacture (CAM) of indirect attachment of an orthodontic device, a manufacturing and using method thereof.

### BACKGROUND ART

A set of teeth in normal occlusion has an appropriate shape and is required to be positioned with a specific requirement. From a front tooth to a molar, the height is gradually reduced. Only if the front tooth, a canine tooth and the molar are arranged at an appropriate angle of inclination, people can chew, speak, swallow well and have a good appearance.

To correct the mal-aligned or mal-occluded tooth, a bracket or a tube having an orthodontic wire is attached to a front or rear side of the teeth. As a part of the orthodontics repositioning the set of teeth correctly and functionally, a bracket or tube attachment may be successful only when an operator adjusts the height and angle of the bracket or tube properly.

There have been developed a direct attachment or indirect attachment for the orthodontics.

First, the direct attachment which uses various gauges to determine a position performs the bracket or tube attachment with an expensive gauge. Particularly, if the bracket or tube is attached to the molar, the sight is hardly secured and accessibility is lowered. Also, as the attachment operation is performed in the salivating mouth, adhesion may be lowered and the operation may take a lot of time. If the bracket or tube is detached while being used, it may not be attached again to its original position as the target position to maintain the original position for the reattachment may not be determined. Thus, a person who receives the treatment feels uncomfortable and the treatment time may be extended.

There is a direct attachment which uses the naked eye, too. The direct attachment does not use an expensive gauge, but presents disadvantages of using the gauge. Particularly, this method relatively depends on the skill of an operator, which causes failure of realizing various heights and angles. Also, if the bracket or tube is attached again, the consistency and accuracy of the reposition and the angle may be lowered.

To overcome such a limit of the direct attachment, an indirect attachment which uses a plaster cast of a patient's teeth has been developed. The indirect attachment is more precise than the method of using the gauge or the naked eye, and determines a consistent position. In the indirect attachment, a slot position of the bracket or tube is determined by a bent wire or sophisticated tools in mold teeth and then the bracket or tube is attached to the mold teeth. The bracket or tube is transferred from the mold teeth to patient's actual teeth by using various transfer jigs for the bracket or tube to thereby attach the bracket or tube to the actual teeth.

Conventionally, the bracket or tube is attached to a mold such as a plaster cast, and a transfer jig to transfer the bracket or tube to the patient's actual teeth is manufactured manually.

There is an indirect attachment which uses a slot machine. In the indirect attachment, after a mold is installed on a fixture of a tool, proper height, mesial and distal angulation, labial or lingual torque, thickness (in & out) and rotation are measured and then the slot position of the bracket or tube is determined by using another element of the tools. Then, the bracket or tube is transferred to the patient's actual teeth by a transfer jig.

### DISCLOSURE OF INVENTION

However, the indirect attachment using the mold such as the plaster is less precise and takes a lot of attachment time and overall operation time. Also, the material may be overused.

Accordingly, it is an aspect of the present invention to provide a transfer jig for a bracket or tube to maintain high precision in attaching a bracket or tube to teeth, a manufacturing and using method thereof.

Also, it is another aspect of the present invention to provide a transfer jig for a bracket or tube to reduce attachment time of a bracket of a tube, a manufacturing and using method thereof.

Also, it is another aspect of the present invention to provide a transfer jig for a bracket or tube to provide excellent reproduction or realization and improve credibility.

Also, it is another aspect of the present invention to provide a transfer jig for a bracket or tube to improve adhesion, manufacturing and using methods thereof.

Further, it is another aspect of the present invention to provide a transfer jig for a bracket or tube which is cost effective and improves user's convenience, manufacturing and using methods thereof.

Additional aspects and advantages of the general inventive concept will be set forth in part in the description which follows and, in part, will be obvious from the description, or may be learned by practice of the general inventive concept.

The foregoing and/or other aspects of the present invention can be achieved by providing a transfer jig for a bracket or a tube to perform an orthodontic operation to an actual tooth of a patient by an indirect attachment using an electronic mold, the transfer jig comprising a fixing unit which has a fixing base including a contact surface corresponding to the actual teeth; and a moving unit which has a first side coupled with the fixing unit and a second side detachably attached to at least one of the bracket and the tube.

According to another aspect of the present invention, the bracket or tube, the moving unit and the fixing unit are arranged and processing data of the contact surface is generated from the electronic mold formed by a three-dimensional scanning based on a mold of the actual tooth.

According to another aspect of the present invention, the contact surface is CNC (computerized numerical control) processed according to a Boolean operation.

According to another aspect of the present invention, the bracket or tube comprises a slot through which an arch wire passes to connect the bracket or the tube, and the moving unit is detached along the coupling direction of the arch wire to the slot.

According to another aspect of the present invention, further comprising a coupling tie to couple the moving unit and the bracket or the tube, wherein the moving unit comprises an insert bar to be coupled with a slot of the bracket or tube, and a tie slot is formed in an area adjacent to the insert bar and the moving arm, and is penetrated by the coupling tie.

The foregoing and/or other aspects of the present invention can be achieved by providing a manufacturing and using method of a transfer jig for a bracket or tube to perform an orthodontic operation of an actual tooth of a patient by an indirect attachment using an electronic mold, the method comprising forming an electronic mold by using a three-dimensional measuring method with a mold from the actual tooth; and arranging a transfer jig for a bracket or tube which has the bracket or tube, a fixing unit including a fixing base having a contact surface corresponding to the actual tooth and a moving unit having a first side coupled with the fixing unit and a second side detachably attached to the bracket or tube, in the electronic mold.

According to another aspect of the present invention, further comprising CNC (computerized numerical control) processing the contact surface according to a Boolean operation.

According to another aspect of the present invention, further comprising coupling the moving unit and the bracket or tube applied with an adhesive to be attached to the actual tooth; attaching the contact surface of the fixing unit to the actual tooth; and coupling the bracket or tube and the moving unit connected with each other to the fixing unit to rotate with respect to the fixing unit.

According to another aspect of the present invention, further comprising removing an excessive adhesive and drying the adhesive after the bracket or tube is positioned in a target position of the actual teeth; separating the moving unit from the bracket or the tube; and separating the fixing unit from the actual tooth.

### BRIEF DESCRIPTION OF THE DRAWINGS

These and other aspects and advantages of the present general inventive concept will become apparent and more readily appreciated from the following description of the embodiments, taken in conjunction with the accompany drawings of which:

FIG. 1 is a perspective view of a bracket or a tube and a transfer jig for a bracket or tube arranged in an electronic mold according to an exemplary embodiment of the present invention;

FIG. 2 is a perspective view of a fixing unit in FIG. 1 operating in a CNC equipment;

FIG. 3 is an exploded perspective view of the transfer jig for the bracket or tube in FIG. 1;

FIGS. 4 to 9 are perspective views of attaching and detaching the bracket or tube to/from actual teeth; and

FIG. 10 is a flowchart of a manufacturing and using method of the transfer jig for the bracket or tube.

### MODES FOR CARRYING OUT THE INVENTION

Reference will now be made in detail to the embodiments of the present general inventive concept, examples of which are illustrated in the accompanying drawings, wherein like reference numerals refer to like elements throughout. The embodiments are described below in order to explain the present invention by referring to the figures.

Hereinafter, a transfer jig for a bracket or a tube and a method of transferring the bracket according to the present invention will be described in detail with reference to drawings.

Hereinafter, an orthodontic device which uses a computer aided design (CAD) or computer aided manufacture (CAM) of an indirect attachment will be described as an example. Equipment which measures or manufactures a transfer jig for a bracket or tube includes a three-dimensional measurement program and an equipment controlled by a computerized numerical control (CNC) to manufacture the transfer jig for the bracket or tube. Among the CNC equipment, a multi-axis CNC equipment which has three axes using CAM will be described as an example.

Hereinafter, the manufacturing and using method of a transfer jig 100 for a bracket or tube will be described sequentially.

<Operation of Arranging a Bracket or a Tube and a Transfer Jig for a Bracket or a Tube in an Electronic Mold>

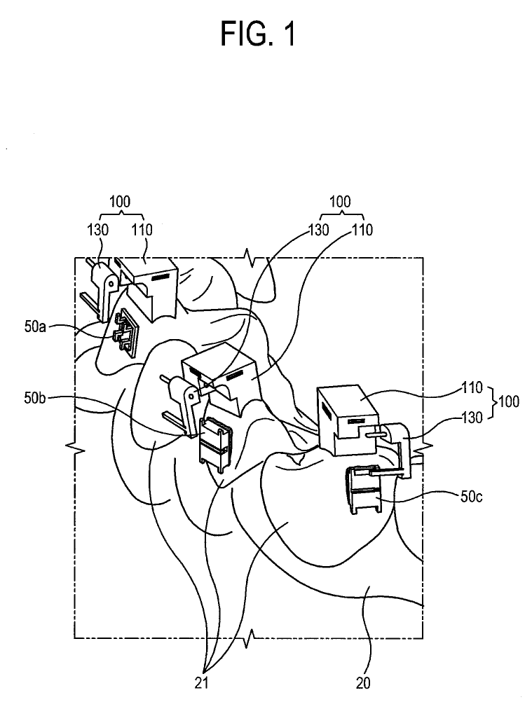

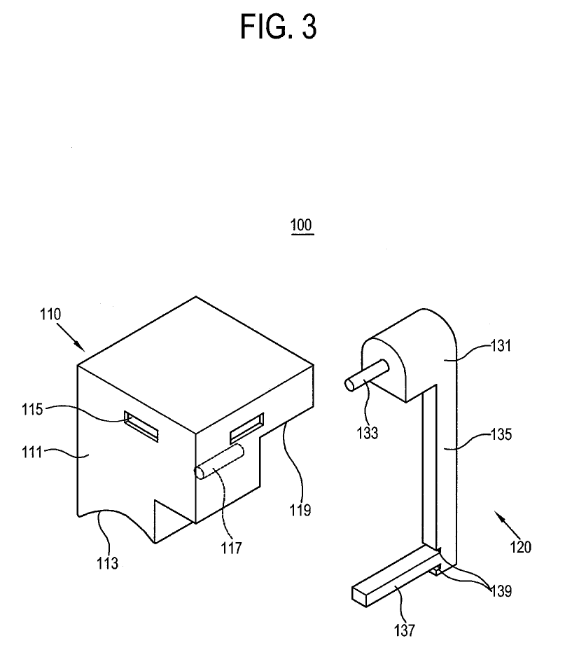

As shown in FIGS. 1 to 9, a transfer jig 100 for a bracket or tube includes a fixing unit 110 and a moving unit 130.

Hereinafter, teeth include mold teeth 21 and actual teeth 20 for convenience, and can be translated into the mold teeth 21 or the actual teeth 20 depending on the context.

As shown in FIG. 1, brackets or tubes 50a, 50b and 50c include a general bracket 50a, and tube type brackets 50b and 50c which block a part of or overall slot (not shown) of the general bracket 50a not to detach an arch wire 40 therefrom. In the present invention, the three kinds of brackets or tubes 50 are employed, but those three brackets or tubes 50 are called the general bracket 50a for convenience and may be distinguished as necessary.

Hereinafter, a virtual bracket 50 and a virtual transfer jig 100 for a bracket or tube which are used in the electronic mold 20 may be used together with the bracket 50 and the transfer jig 100 for the bracket or tube attached to patient's actual teeth without being distinguished particularly.

The electronic mold 20 includes a virtual mold which is formed by three-dimensional scanning a mold (not shown) such as a plaster cast of patient's actual teeth 30. The electronic mold 20 includes a plurality of mold teeth 21 which corresponds to the patient's actual teeth 30. That is, three-dimensional data of the mold teeth 21 formed in the electronic mold 20 may be achieved from the mold by using a measuring program such as CAD or a three-dimensional measuring method or device including the CNC equipment 140. The three-dimensional measuring device and method may be used by each user or may be shared to reduce costs. The electronic mold 20 formed by measuring the mold may be given to a user together with the program as necessary. Thus, a user may properly arrange the bracket 50, the moving unit 130 and the fixing unit 110 according to a patient's various set of teeth to have the most effective arrangement. Also, costs and time may be reduced.

The height and angle of various parts of the mold teeth 21 in the electronic mold 20 may be three-dimensional measured. Thus, the virtual bracket 50 attached to the actual teeth 30 are arranged in the mold teeth 21 first and then the transfer jig 100 for the bracket or tube is arranged in the bracket 50 and the mold teeth 21 to obtain the required data.

The mold teeth 21 are formed in the electronic mold 20 and are based on the mold corresponding to the actual teeth 30. The mold teeth 21 include 24 to 28 upper and lower teeth like the actual teeth 30.

The mold teeth 21 corresponding to the actual teeth may be measured to acquire data about the three-dimensional structure of the actual teeth 30. That is, the difficulty of measuring the actual teeth 30 due to a user's movement may be prevented and the accurate information about the actual teeth 30 may be acquired from the data about the mold teeth 21.

The actual teeth 30 refer to teeth in the mouth of a patient. The actual teeth 30 have various shapes and sizes depending on the arrangement of the set of teeth and size of the teeth 30. An operator may attach the bracket 50 and the transfer jig 100 for the bracket or tube manufactured by the data based on the electronic mold 20, to the actual teeth 30. The actual teeth 30 include a central incisor, a lateral incisor, a canine tooth, a first premolar, a second premolar, a first molar and a second molar from the front side. Hereinafter, each of the actual teeth 30 is not distinguished for convenience. As shown in FIG. 1, the actual teeth 30 include upper and lower teeth, but only the lower teeth will be described as representative teeth. If the bracket 50 and the transfer jig 100 for the bracket or tube are attached to upper teeth, following description may have different directions.

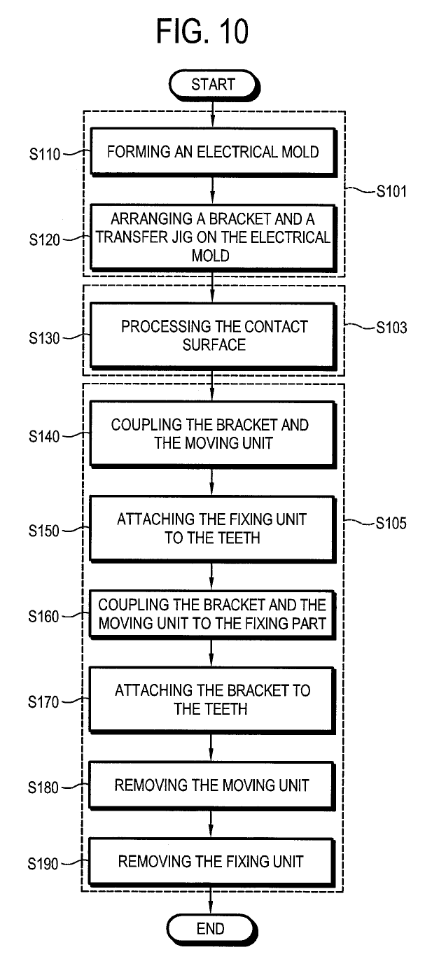

FIG. 10 illustrates an operation S101 of arranging the bracket 50 and the transfer jig 100 for the bracket or tube in the electronic mold 20 and generating data.

As shown in FIG. 10, a virtual electronic mold 20 is formed from the teeth such as plaster of patient's actual teeth with the three-dimensional measuring means and method (S110). Three-dimensional software may be provided to measure and manage data of the mold teeth 21 of the electronic mold 20.

As the status of the actual teeth 30 is precisely measured, precise data may be generated. Even though such measuring and arranging operations may be performed by individual dental clinics, an additional operation body may perform the operations if the measuring device is expensive. As individual dental clinics use the data offered by the operation body to manufacture and use the bracket 50 and the transfer jig 100 for the bracket or tube, costs are reduced and precision can improve with the precise data.

As shown in FIGS. 1 and 10, the bracket 50, the fixing unit 110 and the moving unit 130 which have predetermined sizes are virtually arranged in the mold teeth 21 of the electronic mold 20 (S120). Thus, data about a contact surface 113 of the fixing unit 110 interfering with the mold teeth 21 may be generated precisely.

<Operation of Manufacturing Transfer Jig for Bracket or Tube>

The bracket 50 is attached to the actual teeth 30 based on data such as height and position from the mold teeth 21 to correct the mal-aligned or mal-occluded teeth of a patient. The bracket 50 includes a bracket main body 51, a slot 53, a slot cover (not shown) and a tie wing 57. The bracket 50 may perform the orthodontic operation of the actual teeth 30 by the force from the arch wire 40 with an auxiliary elastic member (not shown) after being attached to the actual teeth 30.

The bracket main body 51 is attached to the actual teeth 30 and has enough strength to transfer the force from the arch wire 40 to the actual teeth 30. The slot 53 is formed in the bracket main body 51 to accommodate the arch wire 40 therein. The bracket main body 51 is strongly attached to the actual teeth 30 by an adhesive 70. The position and angle of the bracket main body 51 attached to the actual teeth 30 may be based on the three-dimensional measuring result of the mold teeth 21. Thus, a proper position of the bracket 50 to perform the orthodontic operation may be determined by a simulation result of the electronic mold 20.

The slot 53 is formed in the bracket main body 51 and accommodates the arch wire 40 therein. The slot 53 is depressed in the bracket main body 51 as an example, but may vary. The moving unit 130 is detached in a lengthwise direction of the slot 53.

The slot cover crosses and blocks the slot 53. Particularly, the slot cover is formed in the tube type brackets 50b and 50c, and prevents the arch wire 40 accommodated in the slot 53 from being separated to the outside. The slot cover may be coupled with the bracket main body 51 to be separated by a predetermined external pressure as necessary.

The tie wing 57 supports a ligature wire (not shown) while the ligature wire is wound to prevent the arch wire from being separated. The tie wing 57 extends and protrudes from the bracket main body 51, but not limited thereto. Alternatively, the tie wing 57 may have various shapes as long as it performs the same function.

The adhesive 70 attaches the bracket 50 to the actual teeth 30 and includes resin as an example.

Preferably, the bracket 50, the fixing unit 110 and the moving unit 130 are manufactured in predetermined size regardless of the size and position of the actual teeth 30. Two types of brackets 50, fixing units 110 and moving units 130 may be provided as necessary. The bracket 50 and the moving unit 130 may be reused. Thus, mass production is available, and manufacturing costs are reduced.

Preferably, materials of the bracket 50 and the moving unit 130 include a metal which is wear resistant to be reused and has sufficient strength.

The fixing unit 110 is virtually arranged in the mold teeth 21 or attached to the actual teeth 30, and coupled with the moving unit 130 to support the bracket 50 while the bracket 50 is transferred. The fixing unit 110 is preferably made in a predetermined size regardless of the size of the mold teeth 21. Preferably, the fixing unit 110 includes plastic as the contact surface 113 of the fixing unit 110 is always processed and the shape of the contact surface 113 varies. The fixing unit 110 includes a fixing main body 111, a clamping groove 115, a pin accommodating groove 117 and a moving main body accommodating groove 119.

The fixing main body 111 is virtually arranged in the mold teeth 21 or attached to the actual teeth 30. The position of the fixing main body 111 attached to the mold teeth 21 may be determined based on the position of the bracket 50 and the size of the moving unit 130 to perform the orthodontic operation with the three-dimensional measuring result of the mold teeth 21. The contact surface 113 and the clamping groove 115 are formed in the bracket main body 51. The fixing main body 111 has a rectangular shape and may vary as necessary. The fixing main body 111 has the moving main body accommodating groove 119 to accommodate the moving unit 130 therein. Preferably, the fixing main body 111 is integrally formed.

The contact surface 113 is arranged in the virtual mold teeth 21, directly attached to the actual teeth 30 and corresponds to a lower part of the fixing main body 111. The contact surface 113 is processed on the basis of the three-dimensional measuring result of the mold teeth as described above. The data about the processed contact surface 113 may be generated based on the proper arrangement position of the bracket 50, the size of the moving unit 130 and the size of the fixing unit 110. The contact surface 113 is processed by Boolean operation widely used in the CNC equipment 140 as one of the three-dimensional processing methods. The CNC equipment 140 is not very expensive and a user may purchase the CNC equipment 140 to process the contact surface 113 by himself/herself. Thus, even if the fixing unit 110 is missing or damaged, a user or operator may conveniently reprocess the contact surface 113.

The processing equipment of the contact surface 113 varies and particularly includes RP (rapid prototyping) equipment and the CNC equipment 140. Hereinafter, the two equipments will be compared.

The RP equipment is expensive and has relatively no limitation in processing shapes. The RP equipment is middle precise and requires expensive processing material costs. For example, the RP equipment costs USD200,000.00 and the material costs are about USD50.00. The processing precision is 40 μm to 80 μm.

The CNC equipment 140 according to the present invention has limited processing shapes compared to the RP equipment. The CNC equipment 140 is less expensive than the RP equipment, but provides higher precision. The CNC equipment 140 may have tool interference. The CNC equipment 140 according to the present invention costs USD5,000.00, which is less expensive than the RP equipment. The material costs of the CNC equipment 140 are several dollars and less expensive than the RP equipment. The processing precision is 10 μm.

The processed part of the fixing main body 111 of the fixing unit 110 having the predetermined size is minimized to facilitate mass production and to reduce costs.

A user may easily determine the position of the bracket 50 on the actual teeth 30 based on the contact surface 113 corresponding to the shape of the actual teeth 30 while the bracket is attached to the actual teeth 30. Thus, the process of determining the position of the bracket 50 attached to the actual teeth 30 has high precision. The ideal orthodontic state is maintained with high precision and the treatment time may be reduced. A patient may reduce costs and time.

The clamping groove 115 is formed in the fixing main body 111. The clamping groove 115 is depressed in at least two of four surfaces of the fixing main body 111. The clamping groove 115 supports the fixing main body 111 while the contact surface 113 is processed. Alternatively, the clamping groove 115 may have various shapes including a circle.

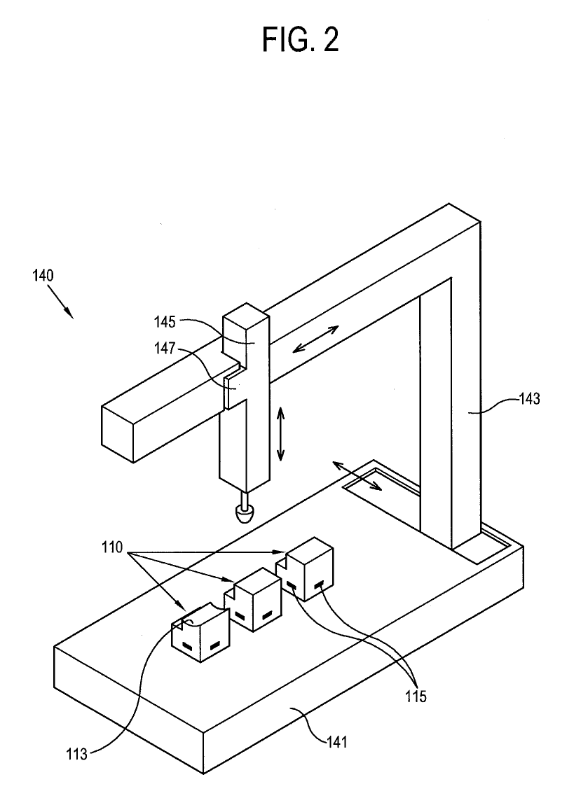

As shown in FIG. 2, the CNC equipment 140 includes a base 141, a frame 143 movable leftward and rightward with respect to the base 141, an upper and lower moving unit 145 having a tool and movable upward and downward and a front and rear moving unit 147 coupled with the frame 143 and movable the upper and lower moving unit 145 frontward and rearward. The frame 143 may move upward and downward by itself.

As shown in FIG. 2, several fixing units 110 are fixed to the CNC equipment 140 with the clamping groove 115, and the contact surface 113 of the fixing units 110 may be processed by data inputted to the CNC equipment 140.

The pin accommodating groove 117 accommodates a moving pin 133 of the moving unit 130 to rotate the moving unit 130 with respect to the fixing unit 110. The pin accommodating groove 117 may be engaged with the moving pin 133 to rotate. Preferably, the pin accommodating groove 117 and the moving pin 133 are coupled with each other with a tolerance to be engaged with each other and maintain the coupled state under predetermined external force and below.

Realization of the bracket 50 may improve while the moving unit 130 is stably coupled with the fixing unit 110 to rotate the bracket 50. Precision of the attachment position of the bracket 50 coupled with the transfer jig 100 for the bracket or tube may improve.

As the bracket 50 rotates with respect to the fixing unit 110, a user or operator presses the bracket 50 to the actual teeth 30 to thereby improve adhesion of the bracket 50 attached to the actual teeth 30.

The moving main body accommodating groove 119 is depressed in a right lower part from the front of the fixing main body 111 and secures a space to rotate the moving main body 131. The moving main body accommodating groove 119 may alternatively be provided in various areas of the fixing main body 111 depending on upper, lower, left and right positions of the teeth so that the moving unit 130 is easily coupled with the fixing unit 110.

A first side of the moving unit 130 is coupled with the fixing unit 110 and a second side is coupled with the bracket 50. Preferably, the moving unit 130 includes a metal to minimize deformation during a transferring process. The moving unit 130 includes the moving main body 131, the moving pin 133, a moving arm 135 and an insert bar 137. The moving unit 130 further includes a tie slot 153. The moving unit 130 has the same size regardless of each tooth and is preferably formed integrally.

The moving unit 130 is coupled with or decoupled from the slot 53 in a direction of coupling the arch wire to the slot 53 of the bracket 50.

Thus, the moving unit 130 and the bracket 50 may be coupled with each other or decoupled from each other easily. As the bracket 50 rotates with respect to the fixing unit 110, it can be used conveniently.

The moving main body 131 is accommodated in the moving main body accommodating groove 119 of the fixing main body 111. The moving pin 133 coupled with the fixing unit 110 extends from the first side of the moving main body 131. The moving arm 135 extends from the second side of the moving main body 131.

The moving pin 133 extends from the left side of the moving main body 131 and is coupled with the pin accommodating groove 117. The moving pin 133 has a long, round bar shape.

Thus, the moving main body 131 may rotate with respect to the fixing unit 110 by the moving pin 133.

The moving arm 135 extends from a lower side of the moving main body 131. The insert bar 137 extends from an end part of the moving arm 135.

The insert bar 137 is provided in the end part of the moving arm 135 and coupled with the slot 53 of the bracket 50. The insert bar 137 corresponds to the shape of the slot 53.

The tie slot 153 is formed in the insert bar 137 or the moving arm 135 to support a coupling tie 170. The tie slot 153 preferably has a circular shape corresponding to the shape of the coupling tie 170, but may vary including a rectangular shape.

The coupling tie 170 enables the transfer jig 100 for the bracket or tube and the bracket 50 to be coupled with each other and maintain the coupling state. The coupling tie 170 is engaged with the tie slot 153 of the moving unit 130 and enables the bracket 50 and the transfer jig 100 for the bracket or tube to be coupled with each other.

As described above, the operation S103 of processing the fixing unit 110 will be described with reference to FIG. 10.

The contact surface 113 of the fixing unit 110 is processed by the CNC equipment 140 based on the data generated by arranging the fixing unit 110 in the electronic mold 20 (S130). In this case, the clamping groove 115 of the fixing main body 111 allows the CNC equipment 140 to easily support the fixing main body 111. As the CNC equipment 140 is not very expensive, it can be prepared in each dental clinic to process the contact surface 113 corresponding to the mold teeth 21. That is, the contact surface 113 may be processed by the CNC equipment 140 having software using data from the electronic mold 20.

Thus, a user may finish the operation in short time.

<Operation of Using Transfer Jig for Bracket or Tube>

An operation S105 of using a transfer jig for a bracket or tube includes several operations as follows.

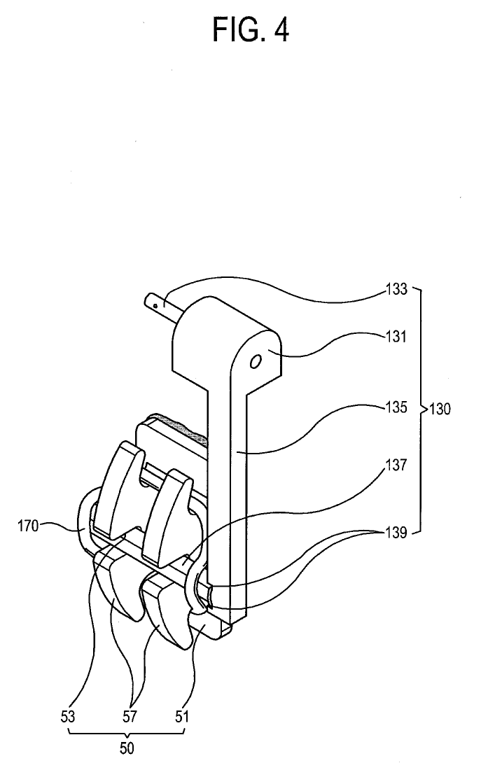

As shown in FIGS. 4 and 10, the bracket 50 is coupled with the moving unit 130 (S140). In this case, the moving unit 130 is coupled with the slot 53 of the bracket 50 and the adhesive 70 is applied to the rear side of the bracket main body 51 attached with the actual teeth 30. Preferably, a direction of coupling the moving unit 130 to the slot 53 is the same as the direction of coupling the arch wire 40 to the slot 53. That is, the moving unit 130 is preferably coupled in a transverse direction, i.e. a lengthwise direction of the slot 53.

The coupling tie 170 is preferably supported by the tie wing 57 of the moving unit 130 and the tie slot 139 of the moving unit 130 so that the coupling state of the bracket 50 and the moving unit 130 is maintained.

Then, a user or operator may easily couple the moving unit 130 to the bracket 50, and the coupling state may not be deformed.

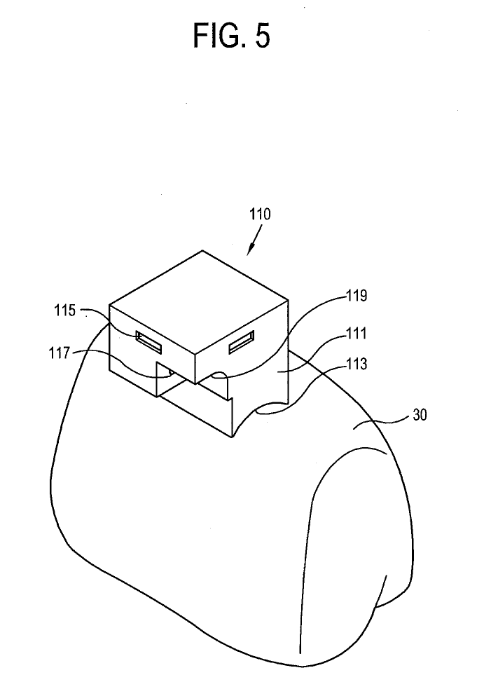

As shown in FIGS. 5 and 10, the contact surface 113 of the fixing unit 110 processed by the CNC equipment 140 is attached to the actual teeth 30. That is, the contact surface 113 is arranged in the same position of the actual teeth 30 based on the data from the electronic mold 20, and the fixing unit 110 is attached.

Thus, a user or operator may easily attach the fixing unit 110 to the actual teeth 30 by using the contact surface 113.

Here, the operation S140 of coupling the bracket 50 and the moving unit 130 and the operation S150 of attaching the fixing unit 110 to the actual teeth 30 may be performed simultaneously.

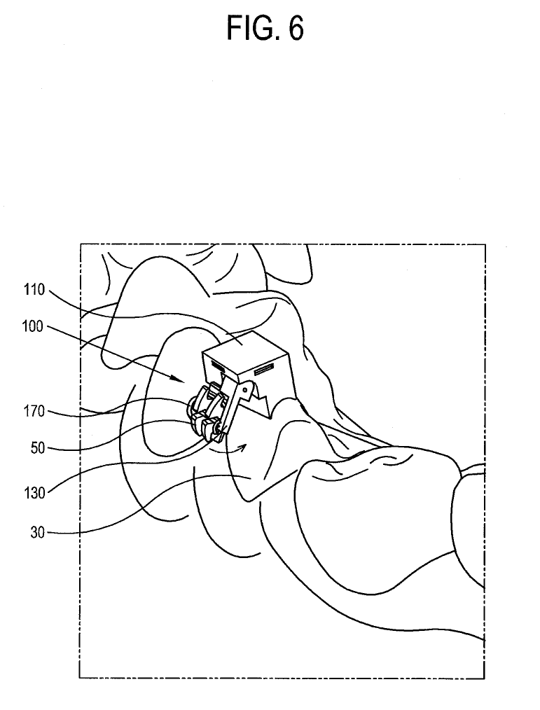

As shown in FIGS. 6 and 10, the coupled bracket 50 and the moving unit 130 are connected to the fixing unit 110 (S160). The insert bar 137 of the moving unit 130 is accommodated in the slot 53 of the bracket 50 and the moving pin 133 of the moving unit 130 is connected to the pin accommodating groove 117 of the fixing unit 110. That is, the bracket 50 is rotatably coupled with the fixing unit 110.

A user or operator may precisely and easily attach the bracket 50 to the correct position of the actual teeth 30, and high precision may be maintained during the attaching process.

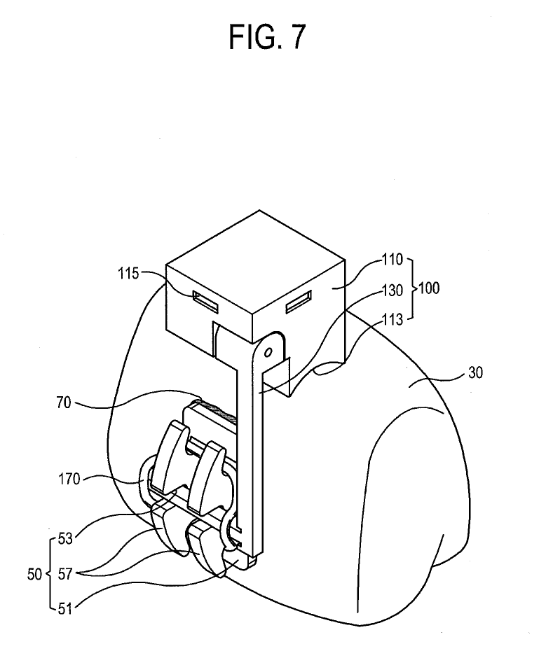

As shown in FIGS. 7 and 10, the bracket 50 is attached to the actual teeth 30 (S170). The bracket 50 is attached to the actual teeth 30 by the adhesive 70 applied to the bracket 50. At this operation, a user can press the bracket 50 with respect to the fixing unit 110, and the adhesion of the bracket 50 may be maintained close to a direct attachment.

The bracket 50 may be attached to the precise position of the actual teeth 30. The excessive adhesive 70 is removed between the bracket 50 and the actual teeth 30. Then, the adhesive 70 is dried by emitting light.

As a user may press the bracket 50 to the actual teeth 30, the adhesion of the bracket 50 may be enhanced.

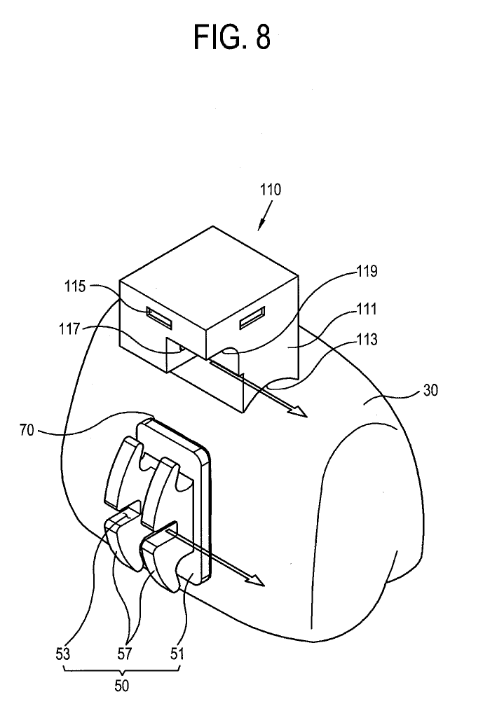

As shown in FIGS. 8 and 10, the moving unit 130 is separated from the bracket 50 and the fixing unit 110 (S180). That is, in the separation process, the moving unit 130 is separated from the slot 53 of the bracket 50 in an opposite direction of coupling the arch wire 40. That is, the moving unit 130 is separated from a distal direction to a mesial direction which is opposite to being coupled from the mesial direction to the distal direction (refer to an arrow direction in FIG. 8). A user may attach or detach the bracket 50 not to cause interference with another bracket 50 or other obstacles in the mouth.

Thus, a user may easily separate the moving unit 130 from the bracket 50 and the fixing unit 110.

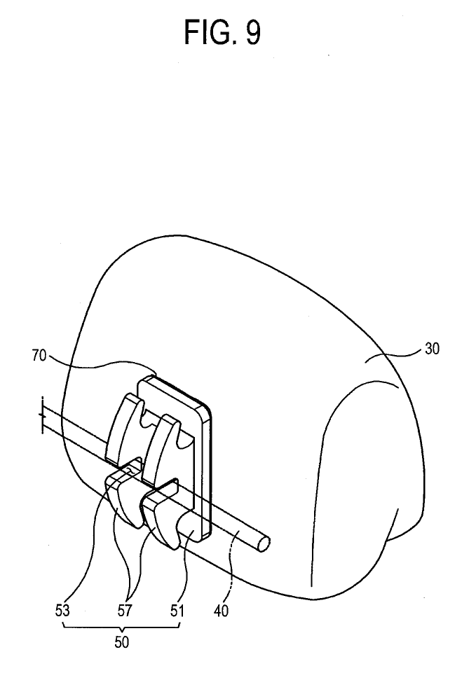

As shown in FIGS. 9 and 10, the fixing unit 110 is separated from the actual teeth 30 (S190). The contact surface 113 of the fixing unit 110 is separated from the actual teeth 30.

Then, the arch wire 40 is accommodated in the slot 53 of the bracket 50, and the arch wire 40 is not separated from the slot 53 by the ligature wire or the slot cover supported by the tie wing 57. The force generated by the arch wire 40 is transferred to the actual teeth 30 through an auxiliary elastic member and the bracket 50 to perform the orthodontic operation.

The realization of the bracket 50 may improve and a user may conveniently use the bracket 50. As the bracket is attached to the correct position with improved precision, the treatment time and costs are reduced. Also, a detailing process may be omitted from the orthodontic process.

According to the present invention, high precision may be maintained while the bracket or tube is attached to patient's teeth.

As detailing time is reduced, the treatment time is also drastically reduced.

As a moving unit is rotatably coupled with a fixing unit to press the bracket or tube to actual teeth, adhesion is better than other indirect attachments, and adhesion as much as that of direct attachment can be expected.

If the bracket or tube is attached again as a transfer jig for the bracket or tube is missing or as the bracket or tube is separated from the actual teeth, it can be conveniently and precisely attached again to the actual teeth by easily manipulating a fixing unit or using the transfer jig.

As CNC equipment installation costs and operation costs are relatively less expensive, individual dental clinics may install and use the CNC equipment. Thus, time to manufacture and use the transfer jig is reduced compared to other indirect attachments and manufacturing time may be reduced considerably.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

1. A transfer jig for a bracket or a tube to perform an orthodontic operation to an actual tooth of a patient by an indirect attachment using an electronic mold, the transfer jig comprising:
a fixing unit which has a fixing main body including a contact surface corresponding to the actual tooth;
a moving unit which has a first side coupled with the fixing unit and a second side detachably attached to at least one of the bracket and the tube, and
the moving unit being detachably attached to the fixing unit in the distal and mesial directions of a patient's tooth and being rotatable with respect to the fixing unit so that one of the bracket and the tube is pressed toward the patient's tooth while the moving unit being coupled with the fixing unit.

2. The transfer jig according to claim 1, wherein the bracket or tube, the moving unit and the fixing unit are arranged and processing data of the contact surface is generated from the electronic mold formed by a three-dimensional scanning based on a mold of the actual tooth.

3. The transfer jig according to claim 1, wherein the contact surface is CNC (computerized numerical control) processed according to a Boolean operation.

4. The transfer jig according to claim 1, wherein the fixing unit comprises a moving main body accommodating groove which is depressedly formed in a first side of the fixing main body, and
the moving unit comprises a moving main body which is accommodated by the moving main body accommodating groove.

5. (canceled)

6. A manufacturing method of a transfer jig for a bracket or a tube to perform an orthodontic operation of an actual tooth by an indirect attachment using an electronic mold, the method comprising:
forming an electronic mold by using a three-dimensional measuring method with a mold from the actual tooth; and
the bracket or the tube, a fixing unit comprising a fixing main body having a contact surface corresponding to the actual tooth and a moving unit having a first side coupled with the fixing unit and a second side detachably attached to at least one of the bracket and the tube, and forming the moving unit to be rotatable with respect to the fixing unit so that one of the bracket and the tube is pressed toward the patient's tooth while the moving unit being coupled with the fixing unit.

7. The method according to claim 6, further comprising (a computerized numerical control) (CNC) processing the contact surface according to a Boolean operation.

8. The method according to claim 7, further comprising:
coupling the moving unit and the bracket or tube applied with an adhesive to be attached to the actual tooth;
attaching the contact surface of the fixing unit to the actual tooth; and
coupling the bracket or tube and the moving unit connected with each other to the fixing unit to rotate with respect to the fixing unit.

9. The method according to claim 8, further comprising:
removing an excessive adhesive and drying the adhesive after the bracket or tube is positioned in a target position of the actual teeth;
separating the moving unit from the bracket or the tube; and
separating the fixing unit from the actual tooth.

10. The transfer jig according to claim 2, wherein the contact surface is CNC (computerized numerical control) processed according to a Boolean operation.

11. A transfer jig for a bracket or a tube to perform an orthodontic operation to an actual tooth of a patient by an indirect attachment using an electronic mold, the transfer jig comprising:
a fixing unit which has a fixing main body including a contact surface corresponding to the actual tooth;
a moving unit which has a first side coupled with the fixing unit and a second side detachably attached to at least one of the bracket and the tube;
the bracket or the tube comprising a slot which is formed to be connected with an arch wire connecting the bracket or the tube in the distal and mesial directions of the tooth; and
the moving unit is detachably attached to the fixing unit in a direction where the arch wire is coupled with the slot.

12. The transfer jig according to claim 11, wherein the moving unit is rotatable with respect to the fixing unit so that one of the bracket and the tube is pressed toward the patient's tooth while the moving unit being coupled with the fixing unit.

13. The transfer jig according to claim 11, further comprising a coupling tie to couple the moving unit and the bracket or the tube, wherein the moving unit comprises an insert bar to be coupled with a slot of the bracket or tube, and
a tie slot is formed in an area adjacent to the insert bar and the moving arm, and is penetrated by the coupling tie.

14. The method according to claim 7, wherein the fixing unit comprises a moving main body accommodating groove which is depressedly formed in a first side of the fixing main body, and
the moving unit comprises a moving main body which is accommodated by the moving main body accommodating groove.
